(19) United States
(12) Patent Application Publication
(10) Pub. No.: US 2013/0152400 A1
(43) Pub. Date: Jun. 20, 2013

(54) PERSONAL SHAVING DEVICE HAVING OPPOSING SETS OF BLADES

(71) Applicant: Joaquin Nunez, Sunny Isles, FL (US)

(72) Inventor: Joaquin Nunez, Sunny Isles, FL (US)

(21) Appl. No.: 13/327,932

(22) Filed: Dec. 16, 2011

(51) Int. Cl. B26B 21/40; B26B 21/52

(52) U.S. Cl. 30/47; 30/50

(57) ABSTRACT

A device for shaving human hair is disclosed. The device includes a handle comprising substantially a shaft. The device further includes a blade assembly coupled to a top end of the handle, wherein the blade assembly comprises: i) a frame, ii) a first set of blades coupled to the frame, wherein the first set of blades are angled in a first direction, and iii) a second set of blades coupled to the frame adjacent to the first set of blades, wherein the second set of blades are angled in a second direction substantially opposite the first direction. The device further includes a telescoping rod coupled to a bottom end of the handle.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of personal grooming devices, and more particularly relates to the field of devices for shaving human hair.

### BACKGROUND OF THE INVENTION

Personal shaving devices, usually called razors or safety razors, typically comprise a handle having a blade assembly attached to the top of the handle. The blade assembly includes one or more blades that cut human hair, wherein the blades are positioned at an angle with respect to the handle. A conventional razor requires that the user slide the razor across his skin in such a way that the blades are tilted at about a forty five degree angle against the direction of movement. This allows the sharpened edges of the blades to engage the user's hair at an angle that is desired for cutting hair. Thus, after a sufficient number of sliding movements, a user can shave a desired area of his face, leg or other body part.

One of the drawbacks of a conventional razor, however, is the singular direction of use. Because the blades must contact the hair being cut at a certain angle, a conventional razor must be used in a given direction. Specifically, most conventional blades are constructed to be used in a downwards movement, such that the razor must be slid against the user's skin towards the bottom of the handle. At the completion of each downwards sliding movement, the user must pick up the razor, move the razor back up to a new position and execute another downwards sliding movement. Using a woman's leg as an example, a female user will usually start at the top of her leg, slide the razor against her leg downwards towards her feet, pick up the razor, move the razor back to the top of her leg and then execute another downwards sliding movement against her leg. The female user repeats these steps until the desired area is completely shaved of hair. This conventional method of shaving using known razors, however, can be tedious and time-consuming.

Another drawback of conventional razors is their short length. Although a short razor length is not a problem when shaving easy-to-reach areas, such as an individual's face, it can be difficult to shave difficult-to-reach areas, such as an individual's back, using a conventional razor with a short length. In cases where a user must shave out-of-reach areas of the human body, the user must either contort his body into painful positions in order to reach those positions or engage the assistance of another person. This can be bothersome to individuals who must shave various areas of their bodies on a frequent basis, such as cyclists and swimmers.

Consequently, a need exists to overcome the problems with the prior art as discussed above, and particularly for a more efficient and easy-to-use personal shaving device for shaving an individual's hair.

### SUMMARY OF THE INVENTION

Briefly, according to an embodiment of the present invention, a device for shaving human hair is disclosed. The device includes a handle comprising substantially a shaft. The device further includes a blade assembly coupled to a top end of the handle, wherein the blade assembly comprises: i) a frame, ii) a first set of blades coupled to the frame, wherein the first set of blades are angled in a first direction, and iii) a second set of blades coupled to the frame adjacent to the first set of blades, wherein the second set of blades are angled in a second direction opposite the first direction. The device further includes a telescoping rod coupled to a bottom end of the handle.

In a second embodiment, a device for shaving human hair is disclosed. The device includes a handle comprising substantially a shaft. The device further includes a blade assembly coupled to a top end of the handle, wherein the blade assembly comprises: i) a frame, ii) a first blade cartridge coupled to the frame, wherein the first blade cartridge includes a set of blades angled in a first direction, and iii) a second blade cartridge coupled to the frame adjacent to the first blade cartridge, wherein the second blade cartridge includes a set of blades are angled in a second direction substantially opposite the first direction.

In a third embodiment, a device for shaving human hair is disclosed. The device includes a handle comprising substantially a shaft. The device further includes a blade assembly coupled to a top end of the handle, wherein the blade assembly comprises: i) a rectangular-shaped frame, ii) a first blade cartridge coupled to a front face of the frame, wherein the first blade cartridge includes a set of blades angled in a first direction, and iii) a second blade cartridge coupled to the front face of the frame adjacent to the first blade cartridge, wherein the second blade cartridge includes a set of blades are angled in a second direction substantially opposite the first direction. The device further includes a telescoping rod coupled to a bottom end of the handle.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1 is an illustration of a side view of a shaving device, according to a first embodiment of the present invention.

FIG. 2 is an illustration of the shaving device of FIG. 1, showing the telescoping rod in a retracted position.

FIG. 3 is an illustration of a side view of a shaving device, according to a second embodiment of the present invention.

FIG. 4 is an illustration of a side view of a shaving device, according to a third embodiment of the present invention.

FIG. 5 is an illustration of a perspective view of a blade assembly of the shaving device of FIG. 1, according to one embodiment of the present invention.

FIG. 6 is an illustration of a top view of the blade assembly of FIG. 5.

FIG. 7 is an illustration of a side view of the shaving device of FIG. 1, shown in a disassembled state.

FIG. 8 is an illustration of a side view of the shaving device of FIG. 4, shown in a disassembled state.

FIG. 9 is an illustration of a side view of the shaving device of FIG. 3, shown in a disassembled state.

### DETAILED DESCRIPTION

The present invention solves the problems with the prior art by providing a shaving device with two opposing sets of blades. Each set of blades allows for shaving in one direction. Consequently, since the two sets of blades oppose each other, the device can be used to shave in either direction. The present invention is advantageous since it allows a user to apply the device to his or her skin and shave in either the upwards or downwards direction. Therefore, during shaving, a user can slide the device upwards and downwards against his skin to shave his hair, without requiring that the user pick up the device at the end of each movement to reposition the device in a new location. This leads to quicker and more thorough shaving sessions, as well as higher quality shaving of hair. The present invention is further advantageous because it provides a telescoping handle to facilitate shaving difficult-to-reach areas of the human body, such as an individual's back. Finally, the present invention is further advantageous since it is manufactured using a minimum number of pieces and moving parts, which facilitates repair and results in a lower probability of failure or malfunction.

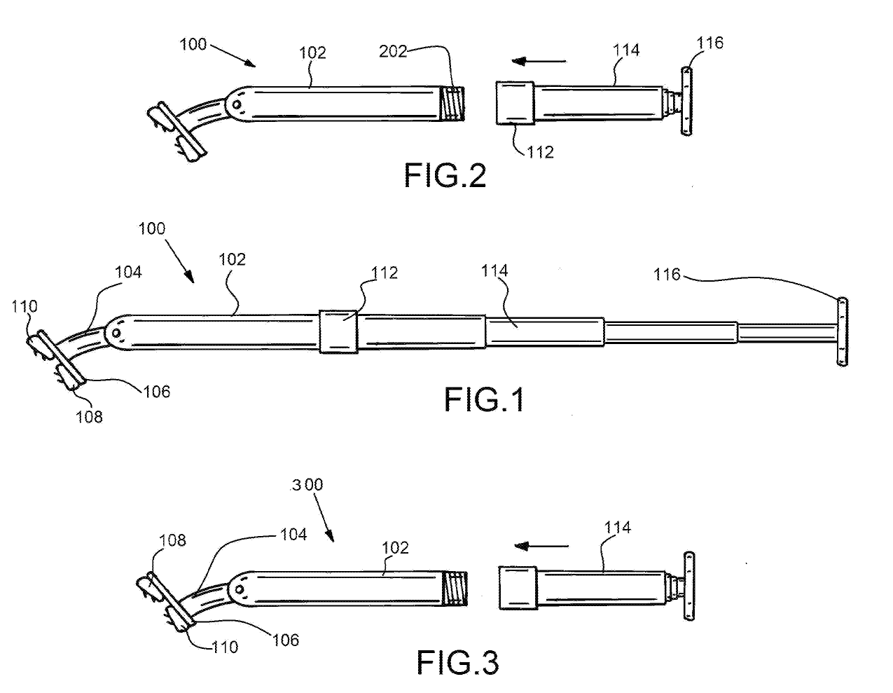

FIG. 1 is an illustration of a side view of a shaving device 100, according to a first embodiment of the present invention. The device 100 includes a handle 102 comprising substantially a shaft with a neck 104 protruding from the top end of the handle 102. The neck 104 may be curved or straight. Attached to a distal end of the neck 104 is a blade assembly, comprising a frame 106, a first blade cartridge 108 and a second blade cartridge 110. A blade cartridge is well known in the art and comprises a disposable plastic enclosure into which is embedded a set of one or more parallel narrow blades. FIG. 1 shows that each cartridge 108 and 110 includes two parallel narrow blades, which are viewed in profile. FIG. 1 further shows that the blades of cartridge 108 point in a direction that is substantially opposite from the direction in which the blades of cartridge 110 are pointing. That is, the blades of cartridge 108 are opposed in direction to the blades of cartridge 110.

Also shown in FIG. 1 is a telescoping rod 114 having a threaded female element 112 that screws onto a threaded male element 202 located at the bottom end of the handle 102. The telescoping rod 114 may be extended, as shown in FIG. 1, to provide an elongated handle that may be used by an individual to shave difficult-to-reach places, such as an individual's back. The base 116 of the telescoping rod 114 may be a circular planar element that may be used as a stand for the device 100 or may be used as a hold for extending or retracting the telescoping rod 114. FIG. 2 is an illustration of the shaving device 100 of FIG. 1 showing the telescoping rod 114 in a retracted position.

FIG. 3 is an illustration of a side view of the shaving device 300, according to a second embodiment of the present invention. The difference between FIG. 1 and FIG. 3 is that the neck 104 of FIG. 3 is attached to a bottom portion of the frame 106, whereas in FIG. 1, the neck 104 is attached to a middle portion of the frame 106.

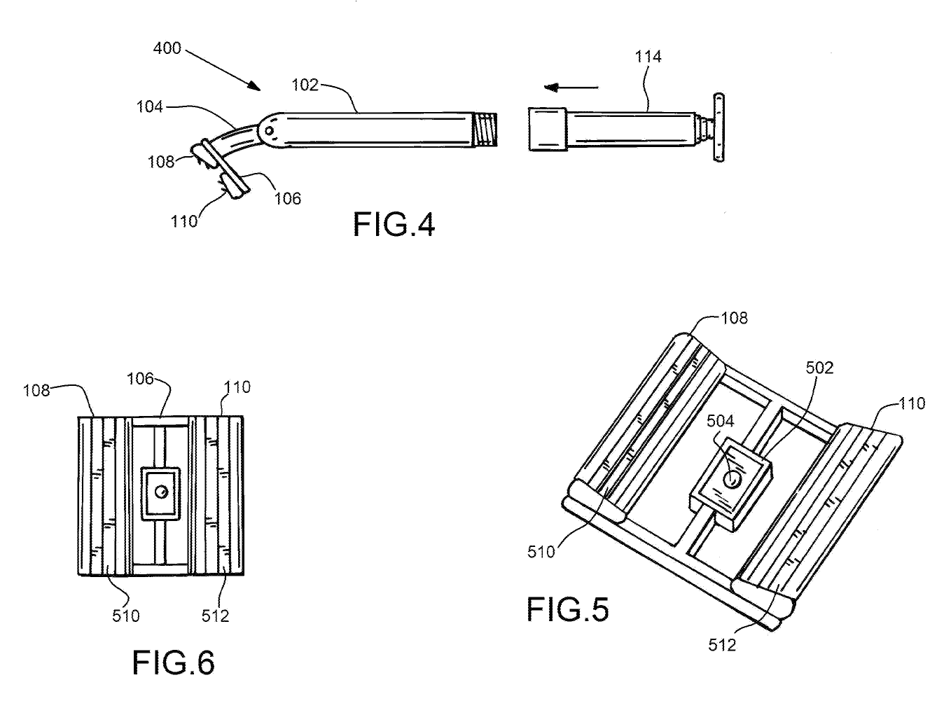

FIG. 4 is an illustration of a side view of a shaving device 400, according to a third embodiment of the present invention. The difference between FIG. 1 and FIG. 4 is that the neck 104 of FIG. 4 is attached to a top portion of the frame 106, whereas in FIG. 1, the neck 104 is attached to a middle portion of the frame 106.

FIG. 5 is an illustration of a perspective view of a blade assembly of the shaving device 100 of FIG. 1, according to one embodiment of the present invention. The blade assembly comprises a rectangular shaped frame 106, a first blade cartridge 108 and a second blade cartridge 110. FIG. 1 shows that cartridge 108 includes two parallel narrow blades 510 and that cartridge 110 includes two parallel narrow blades 512. FIG. 5 further shows that the blades 510 of cartridge 108 point in a direction that is substantially opposite from the direction in which the blades 512 of cartridge 110 are pointing. Specifically, the blades 510 of cartridge 108 are opposed in direction to the blades 512 of cartridge 110.

The frame 106 may comprise a rectangular shape having a first strip running along the rear length of cartridge 108, the second strip running along the rear length of cartridge 110, the third strip connecting a left side of cartridges 108, 110 and the fourth strip connecting a right side of cartridges 108, 110. The cartridge 108 may be removably or permanently coupled to the first strip of frame 106. Likewise, the cartridge 110 may be removably or permanently coupled to the second strip of frame 106. The frame 106 may also comprise a fifth strip running along its middle so as to bisect the rectangle comprising the frame 106, wherein the fifth strip includes a module 502 at its center-point. The module 502 may include an orifice 504 that is used to couple the frame 106 to the handle 102, as described more fully below. FIG. 6 is an illustration of a top view of the blade assembly of FIG. 5.

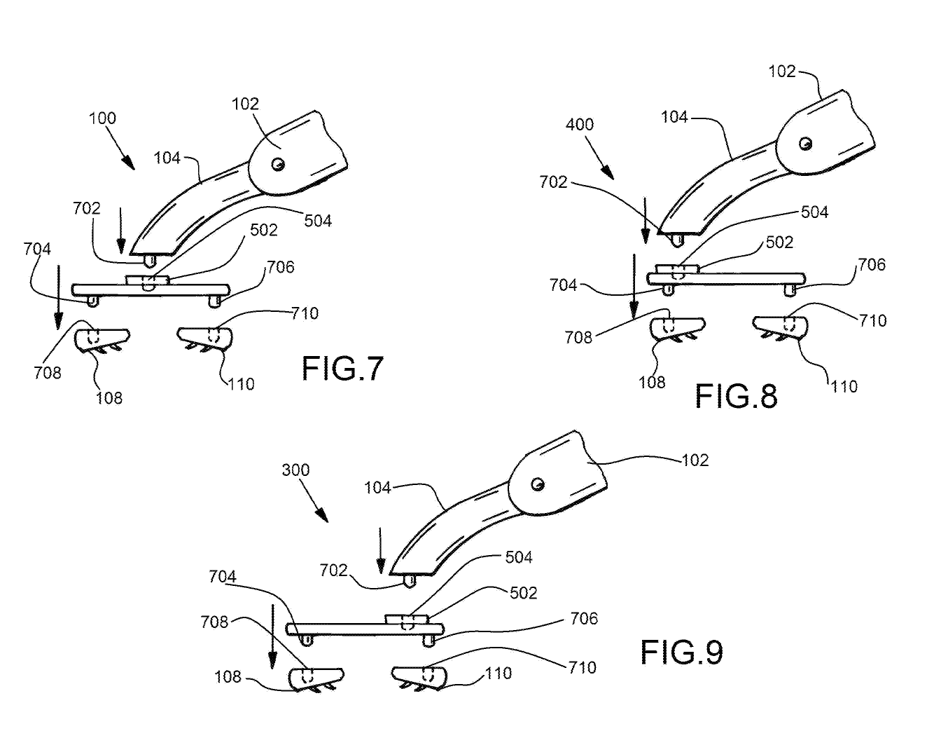

FIG. 7 is an illustration of a side view of the shaving device 100 of FIG. 1, shown in a disassembled state. FIG. 7 shows that the neck 104 comprises a protrusion 702 that may be inserted into the orifice 504 of module 502 so as to couple the neck 104 to the frame 106 using, for example, a friction fit. FIG. 7 further shows that the frame 106 includes a first protrusion 704 for insertion into an orifice 708 of cartridge 108 so as to couple the frame 106 with the cartridge 108 using, for example, a friction fit. FIG. 7 also shows that the frame 106 includes a second protrusion 706 for insertion into an orifice 710 of cartridge 110 so as to couple the frame 106 with the cartridge 110 using.

FIG. 8 is an illustration of a side view of the shaving device 400 of FIG. 4, shown in a disassembled state. The difference between FIG. 7 and FIG. 8 is that the neck 104 of FIG. 8 is attached to a top portion of the frame 106, whereas in FIG. 7, the neck 104 is attached to a middle portion of the frame 106.

FIG. 9 is an illustration of a side view of the shaving device 300 of FIG. 3, shown in a disassembled state. The difference between FIG. 7 and FIG. 9 is that the neck 104 of FIG. 9 is attached to a bottom portion of the frame 106, whereas in FIG. 7, the neck 104 is attached to a middle portion of the frame 106.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A device for shaving human hair, comprising:
a handle comprising substantially a shaft;
a blade assembly coupled to a top end of the handle, wherein the blade assembly comprises: i) a frame, ii) a first set of blades coupled to the frame, wherein the first set of blades are angled in a first direction, and iii) a second set of blades coupled to the frame adjacent to the first set of blades, wherein the second set of blades are angled in a second direction substantially opposite the first direction; and
a telescoping rod coupled to a bottom end of the handle.

2. The device of claim 1, wherein the handle is coupled to the frame of the blade assembly.

3. The device of claim 1, wherein the handle is coupled to the first set of blades.

4. The device of claim 1, wherein the handle is coupled to the second set of blades.

5. The device of claim 2, wherein the handle is coupled to the blade assembly using a friction fit.

6. The device of claim 5, wherein the frame comprises a first strip, a second strip coupled to one end of the first strip so as to create a right angle with the first strip, and a third strip coupled to a second end of the first strip so as to create a right angle with the first strip.

7. The device of claim 6, wherein the telescoping rod comprises a threaded female element on one end, which is coupled to a threaded male element on the bottom end of the handle.

8. A device for shaving human hair, comprising:
a handle comprising substantially a shaft; and
a blade assembly coupled to a top end of the handle, wherein the blade assembly comprises: i) a frame, ii) a first blade cartridge coupled to the frame, wherein the first blade cartridge includes a set of blades angled in a first direction, and iii) a second blade cartridge coupled to the frame adjacent to the first blade cartridge, wherein the second blade cartridge includes a set of blades are angled in a second direction substantially opposite the first direction.

9. The device of claim 8, further comprising a telescoping rod coupled to a bottom end of the handle.

10. The device of claim 9, wherein the handle is coupled to the frame of the blade assembly.

11. The device of claim 9, wherein the handle is coupled to the first blade cartridge.

12. The device of claim 9, wherein the handle is coupled to the second blade cartridge.

13. The device of claim 10, wherein the handle is coupled to the blade assembly using a friction fit.

14. The device of claim 13, wherein the frame comprises a first strip, a second strip coupled to one end of the first strip so as to create a right angle with the first strip, and a third strip coupled to a second end of the first strip so as to create a right angle with the first strip.

15. The device of claim 14, wherein the telescoping rod comprises a threaded female element on one end, which is coupled to a threaded male element on the bottom end of the handle.

16. A device for shaving human hair, comprising:
a handle comprising substantially a shaft;
a blade assembly coupled to a top end of the handle, wherein the blade assembly comprises: i) a rectangular-shaped frame, ii) a first blade cartridge coupled to a front face of the frame, wherein the first blade cartridge includes a set of blades angled in a first direction, and iii) a second blade cartridge coupled to the front face of the frame adjacent to the first blade cartridge, wherein the second blade cartridge includes a set of blades are angled in a second direction substantially opposite the first direction; and
a telescoping rod coupled to a bottom end of the handle.

17. The device of claim 16, wherein the handle is coupled to the frame of the blade assembly.

18. The device of claim 16, wherein the handle is coupled to the first blade cartridge.

19. The device of claim 16, wherein the handle is coupled to the second blade cartridge.

20. The device of claim 17, wherein the handle is coupled to the blade assembly using a friction fit.
